(19) United States
(12) Patent Application Publication
(10) Pub. No.: US 2025/0118516 A1
(43) Pub. Date: Apr. 10, 2025

(54) TRIP DEVICE FOR MANUAL MOTOR STARTER

(71) Applicant: LS ELECTRIC CO., LTD., Anyang-si, Gyeonggi-do (KR)

(72) Inventor: Hyungeun CHO, Anyang-si, Gyeonggi-do (KR)

(21) Appl. No.: 18/835,134

(22) PCT Filed: Mar. 16, 2023
(86) PCT No.: PCT/KR2023/003532

§ 371 Date: Aug. 1, 2024

(30) Foreign Application Priority Data
Apr. 6, 2022 (KR) 10-2022-0042957

(51) Int. Cl. H01H 71/02; H01H 71/16; H01H 83/20

(52) U.S. Cl. CPC H01H 71/0207; H01H 71/164; H01H 83/20

(57) ABSTRACT

The present disclosure relates to a manual motor starter and, more specifically, to a trip device for a manual motor starter. A trip device for a manual motor starter according to an embodiment of the present disclosure comprises: a trip unit body forming the base of a trip unit; a fixed contact coupled to the lower portion of the trip unit body; a heater assembly inserted and coupled to the trip unit body and detecting the heat variation; a coil coupled to the upper portion of the trip unit body; a core unit inserted into the coil; a terminal rod coupled to the core unit and the trip unit body, and having one end portion forming a terminal unit; and an instant trip lever which is rotatably coupled to the trip unit body and is operated by the core unit, wherein a coil attachment portion in which the coil is inserted and installed protrudes from the trip unit body.

### CROSS-REFERENCE TO RELATED APPLICATIONS

This application is the National Stage filing under 35 U.S.C. 371 of International Application No. PCT/KR2023/003532, filed on Mar. 16, 2023, which claims the benefit of earlier filing date and right of priority to Korean Application No. 10-2022-0042957, filed on Apr. 6, 2022, the contents of which are all hereby incorporated by reference herein in their entirety.

### FIELD

The present disclosure relates to a manual motor starter and, more particularly, to a trip device for a manual motor starter.

### BACKGROUND

Generally, a manual motor starter (MMS) is a device used in an electric line with a rated insulation voltage of 690 V AC or less (a frequency of 50 Hz or 60 Hz), and is installed at a front end of a motor and operates during occurrence of a fault current due to an overcurrent, a phase loss, a phase reverse, a short circuit, a ground fault, etc. to block a system to thereby protect the system and load equipment.

FIG. 1 is a cutaway perspective view of a manual motor starter in the related art.

The manual motor starter includes, in an enclosure 9, a trip unit (or a detection unit) 1 configured to detect occurrence of a fault current such as a an overcurrent, a phase loss, a phase reverse, a short circuit, a ground fault, etc., an opening/closing operating mechanism 2 configured to trip the manual motor starter according to a detection signal of the trip unit, a contact unit 3 configured to open/close a line in association with operation of the opening/closing operating mechanism, an arc extinguishing unit 4 configured to extinguish an arc generated when contact points of the contact unit are separated during blocking and discharge the generated arc to outside, etc. In addition, an auxiliary contact unit configured to transmit a control signal to an auxiliary device according to operation of the opening/closing operating mechanism may also be included.

In the manual motor starter described above, during a normal electrical connection, a moving contact 5 and a fixed contact 6 of the contact unit are connected to each other to carry current flowing into a terminal on a power source side to a terminal 7 on a load side. However, when a fault current occurs, the detection unit 1 detects the fault current to drive the opening/closing operating mechanism 2, and due to operation of the opening/closing operating mechanism 2, a movable contact point of the movable contact 5 is separated from a fixed contact point of the fixed contact 6 to block current from flowing toward the load side.

FIGS. 2 and 3 are a longitudinal view and an exploded perspective view of the detection unit in the manual motor starter in the related art, respectively.

The trip device 1 of the manual motor starter in the related art has a configuration as described below.

The detection unit 1 includes a trip body 11 constituting a base of the detection unit 1, a fixed contact 6 coupled to a lower portion of the trip body 11, a heater assembly (a bimetal 13, a heater 15, and a bimetal supporter 17) coupled to an upper portion of the trip body 11 and detect heat, a coil assembly (a coil 21 and a bobbin 23) coupled to an upper portion of the bimetal supporter 17, core units (an upper core 31, a lower core 33, and a core spring 35) inserted into the coil 21, a terminal rod 25 coupled to the upper core 31 and the trip body 11, and an instant trip lever 19 rotatably coupled to the trip body 11.

A process of assembling the detection unit 1 is described below.
1) The trip body 11 is prepared.
2) The fixed contact 6 is assembled onto a lower portion of the trip body 11.
3) The heater assembly is assembled onto an upper portion of the trip body 11.
4) The coil assembly is assembled from above the heater assembly onto the trip body 11.
5) The core units are assembled in the coil.
6) The terminal rod 25 is assembled onto the trip body 11 and the coil assembly.
7) An instant lever 9 is assembled onto the trip body 11.

In a manufacturing process in the related art, a method of mounting the bobbin 23 on a coil winding facility, and then, winding the coil 21 is performed to wind the coil 21 in the detection unit. However, this method may deteriorate workability and productivity, and since two types of mold components such as the trip body 11 and the bobbin 23 are needed to constitute the detection unit, assembly defects frequently occur and assembling property is worsened.

### SUMMARY

Therefore, to obviate those problems, an aspect of the detailed description is to provide a trip device for a manual motor starter, the trip device having a streamlined number of components and enhanced assembly property.

To achieve these and other advantages and in accordance with the purpose of the present disclosure, as embodied and broadly described herein, there is provided a trip device for a manual motor starter, the trip device including: a trip unit body constituting a base of a trip unit; a fixed contact coupled to a lower portion of the trip unit body; a heater assembly inserted and coupled into the trip unit body and configured to detect a heat variation; a coil coupled to an upper portion of the trip unit body; a core unit inserted into the coil; a terminal rod coupled to the core unit and the trip unit body and having one end constituting a terminal unit; and an instant trip lever rotatably coupled to the trip unit body and operated by the core unit, wherein a coil attachment portion into which the coil is installed to be inserted is disposed to protrude on the trip unit body

Here, a contact insertion portion into which the fixed contact is fit to be coupled may be disposed on the trip unit body.

In addition, a terminal mounting portion may be disposed on one end portion of the trip unit body, and a rod fitting hole into which the terminal rod is fit to be coupled may be disposed in the terminal mounting portion.

In addition, the coil attachment portion may be disposed on an upper support plate of the trip unit body, and a side wall may be disposed between the upper support plate and a support portion of the trip unit body.

In addition, an insertion groove into which the heater assembly may be fit to be coupled is disposed in the side wall.

In addition, the heater assembly may include a heater, a bimetal, and a bimetal support plate, and a plurality of insertion protrusions fit into the insertion groove may be disposed to protrude on the bimetal support plate.

In addition, a shaft groove into which a rotating shaft portion of the instant trip lever may be fit to be coupled is disposed in the side wall.

In addition, the core unit may include a fixed core, a movable core, and a core spring, and the fixed core may be fixed onto an upper surface of the terminal rod.

In addition, a lever pressing portion configured to operate the instant trip lever may be disposed on a lower portion of the movable core.

In addition, a fitting protrusion fit to be coupled into the terminal mounting portion may be disposed on the terminal unit located on a lower surface of the terminal rod.

In addition, the coil attachment portion may be configured to have a shape of a cylinder or a circular pipe.

In addition, the coil attachment portion may be disposed inside the coil.

A trip device for a manual motor starter according to one embodiment of the present disclosure is configured to have a coil attachment portion on a trip unit body to facilitate assembling of a coil. Accordingly, assembling time may be shortened, and assembly defects rarely occur.

Since a bobbin component applied to assembling of a coil in the related art is removed, a number of components is reduced. Accordingly, manufacture and management of components are improved.

### BRIEF DESCRIPTION OF THE DRAWINGS

FIG. 1 is a partially cutaway perspective view of a manual motor starter in the related art.

FIG. 2 is a longitudinal sectional view of a trip device for the manual motor starter in the related art.

FIG. 3 is an exploded perspective view of the trip device for the manual motor starter in the related art.

FIG. 4 is a longitudinal sectional view of a manual motor starter according to one embodiment of the present disclosure.

FIGS. 5 and 7 are operational views of an opening/closing operating mechanism in the manual motor starter according to one embodiment of the present disclosure. FIG. 5 illustrates an on-state, FIG. 6 illustrates an off-state, and FIG. 7 illustrates a trip state.

FIG. 8 is a perspective view of a trip device for the manual motor starter according to one embodiment of the present disclosure.

FIG. 9 is an exploded perspective view of a detection unit of FIG. 8.

FIG. 10 is a perspective view of a trip unit body shown in FIG. 9, as viewed from a different direction.

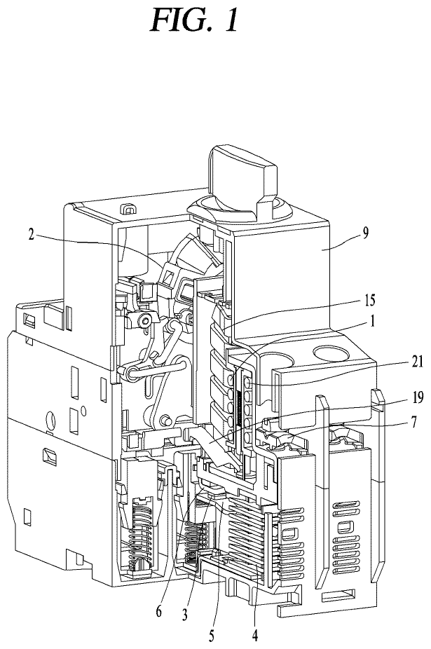

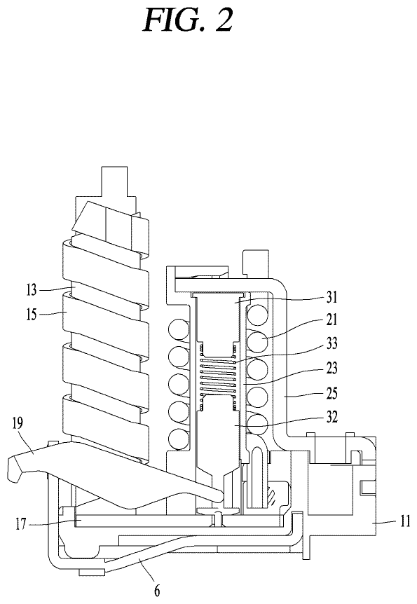

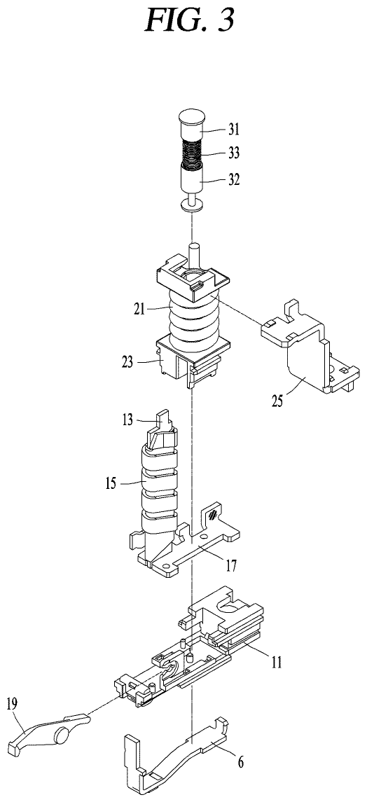

### DETAILED DESCRIPTION

Hereinafter, embodiments of the present disclosure are described with reference to the accompanying drawings. However, this is intended to provide a detailed description so that those of ordinary skilled in the art can easily implement the disclosure, and the technical idea and scope of the present disclosure are limited by the accompanying drawings.

The term “member,” “unit,” or “part” used herein is to indicate components in the present disclosure are not used for any purpose of limitation, and may be omitted.

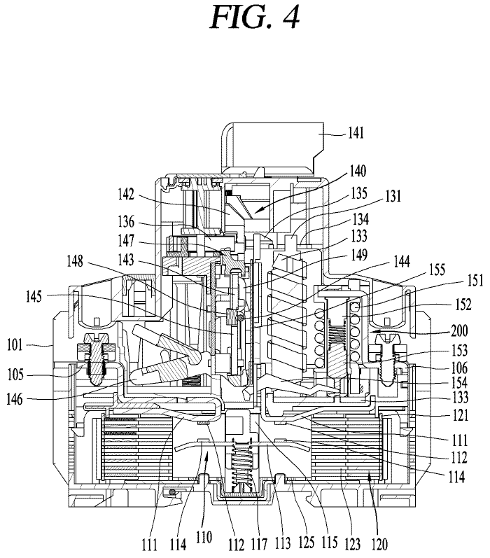

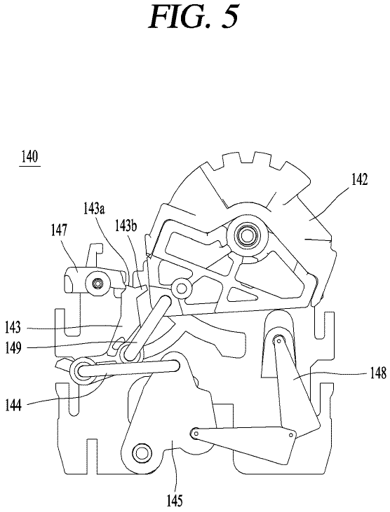

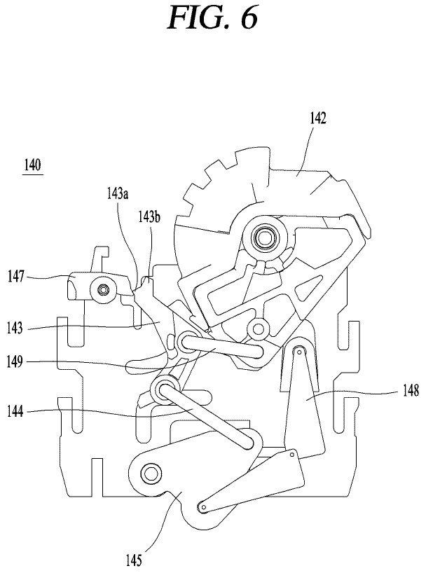

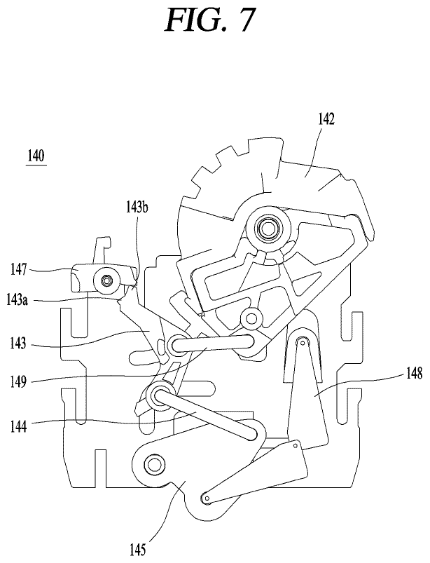

A manual motor starter according to respective embodiments of the present disclosure will be described in detail with reference to the accompanying drawings. FIG. 4 is a longitudinal sectional view of a manual motor starter according to one embodiment of the present disclosure. FIGS. 5 and 7 are operational views of an opening/closing operating mechanism in the manual motor starter according to one embodiment of the present disclosure. FIG. 5 illustrates an on-state, FIG. 6 illustrates an off-state, and FIG. 7 illustrates a trip state.

A trip device for the manual motor starter according to one embodiment of the present disclosure includes a trip unit body 170 constituting a base of a trip unit (a detection unit) 200, a fixed contact 111 coupled to a lower portion of the trip unit body 170, a heater assembly 130 inserted and coupled into the trip unit body 170 and configured to detect a heat variation, a coil 151 coupled to an upper portion of the trip unit body 170, core units 152, 153, and 158 inserted into the coil 151, a terminal rod 160 coupled to the core units and the trip unit body 170, and an instant trip lever 154 rotatably coupled to the trip unit body 170 and operated by the core units, wherein a coil attachment portion 179 into which the coil 151 is inserted is disposed to protrude on the trip unit body 170.

The manual motor starter according to one embodiment of the present disclosure includes the trip unit (or the detection unit) 200 configured to detect occurrence of a fault current such as an overcurrent, a phase loss, a phase reverse, a short circuit, a ground fault, etc. and perform a trip operation, an opening/closing operating mechanism 140 configured to trip the manual motor starter according to a detection signal of the trip unit 200, a contact unit 110 configured to open/close a line in association with operation of the opening/closing operating mechanism 140, an arc extinguishing unit 120 configured to extinguish an arc generated when contact points of the contact unit 110 are separated during blocking and discharge the generated arc to outside, etc.

An enclosure 101 of the manual motor starter is equipped with and supports constituent units or components therein. The enclosure 101 may be made of a synthetic resin material.

The contact unit 110 is fixedly installed in a part of the enclosure 101, and includes the fixed contact 111 connected to a terminal unit 105 on a power source side or a terminal unit 106 on a load side, and a movable contact 113 in contact with or separate from the fixed contact 111 to carry or block a current to a circuit.

The fixed contact 111 is disposed adjacent to the terminal units 105 and 106, respectively. The fixed contacts 111 are respectively equipped with a fixed contact point 112. The fixed contacts 111 are equipped with the fixed contact point 112 made of a material with excellent electrical conductivity and high heat resistance.

The movable contact 113 is disposed to be apart from the fixed contact 111 by a certain distance. The movable contact 113 is installed in a guide mover 115 and may perform linear movement (up and down movement) together with the guide mover 115 toward the fixed contact 111. The movable contact 113 is equipped with a movable contact point 114 made of a material with excellent electrical conductivity and high heat resistance.

A contact spring 117 is disposed below the movable contact 113 to provide elastic force to the movable contact 113 or the guide mover 115.

The arc extinguishing unit 120 is disposed near the contact unit 110. The arc extinguishing unit 120 is disposed to extinguish an arc generated in the contact unit 110 during blocking.

The arc extinguishing unit 120 includes a side plate 121 and a plurality of grids 123 coupled thereto. An arc plate 125 is disposed below the contact unit 110 to guide an arc to the arc extinguishing unit 120.

The detection unit or trip unit 200 is disposed to detect an abnormal trip such as an overcurrent, a fault current, etc. and perform tripping. The trip unit 200 includes a delay trip device configured to detect an overcurrent and an instant trip device configured to detect a fault current (a short-circuit current).

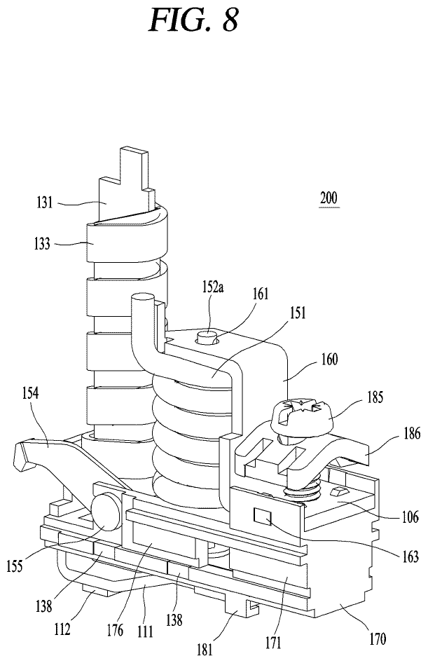

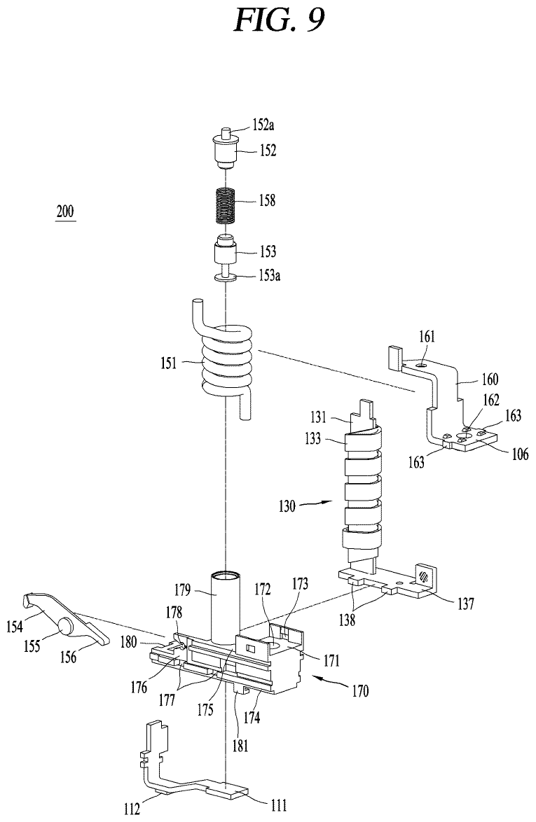

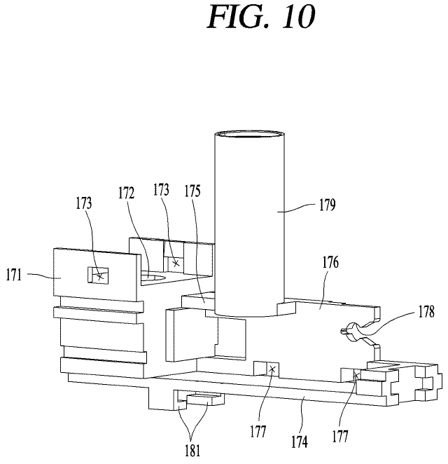

FIGS. 8 to 10 are further referred to. FIG. 8 is a perspective view of the trip device for the manual motor starter according to one embodiment of the present disclosure. FIG. 9 is an exploded perspective view of the detection unit of FIG. 8. FIG. 10 is a perspective view of a trip unit body shown in FIG. 9, as viewed from a different direction.

The delay trip device includes a bimetal 131 connected to the terminal unit 106 on a load side or a heater 133 and configured to be curved by heat generated when an overcurrent flows, a moving plate 134 configured to move by the curving of the bimetal 131, a moving plate lever 135 installed on the moving plate 134 to be moved, and a compensation bimetal 136 configured to be rotated by the moving plate lever 135. The compensation bimetal 136 moves a latch holder 147 of the opening/closing operating mechanism 140 through sequential associated movement between the bimetal 131, the moving plate 134, the moving plate lever 135, and the compensating bimetal 136.

The instant trip device includes a coil 151 configured to generate an induced electromagnetic force when a fault current flows in the terminal unit 106 on a load side, the core unit 152, i.e., a fixed core fixedly installed inside the coil, the core unit 153, i.e., a movable core configured to move by the induced electromagnetic force, the instant trip lever 154 configured to move by receiving force of the movable core 153, and a trip plate 155 configured to move in association with the instant trip level 154 and move the latch holder 147.

The opening/closing operating mechanism 140 is disposed. A user manipulates the opening/closing operating mechanism 140 to open/close the contact unit 110 to carry current (on) or block current (off) to a circuit. FIGS. 4 to 7 may be mainly referred to.

The opening/closing operating mechanism 140 includes a handle 141, a joint gear 142 configured to convert movement of the handle 141 to an orthogonal axis direction, and a first U pin 149, a latch 143, a second U pin 144, and a push link 145 sequentially connected to the joint gear 142 to be associated with each other are disposed.

The first U-pin 149 is disposed between the joint gear 142 and the latch 143, and pushes or pulls the latch 143 according to movement of the joint gear 142.

The second U-pin 144 is disposed between the push link 145 and the latch 143 to mediate an interaction therebetween. That is, the second U-pin 144 pushes or pulls the latch 143 according to movement of the push link 145, or pushes or pulls the push link 145 according to movement of the latch 143.

The latch 143 moves according to relative movement of the first U-pin 149 and the second U-pin 144, and includes an on-off locking portion 143a and a trip locking portion 143b each in contact with the latch holder 145.

The on-off locking portion 143a is a portion in which the latch 143 is restrained to the latch holder 145 during an on-off operation. The on-off locking portion 143a is disposed to partially protrude from a body of the latch 143. The on-off locking portion 143a has an on-off contact surface that meets a side surface of the latch holder 145 at an acute angle.

The trip locking portion 143b is a portion in which the latch 143 is restrained to the latch holder 145 during a trip operation. The trip locking portion 143b is disposed to partially protrude from the body of the latch 143 and be apart from the on-off locking portion 143a by a certain distance. The trip locking portion 143b, compared to the on-off locking portion 143a, is configured to be further apart from the first U pin 149. In other words, a movement trajectory of the trip locking portion 143b, compared to a movement trajectory of the on-off locking portion 143a, is configured to be closer to a center of the latch holder 145. The trip locking portion 143b has a trip contact surface that meets a lower surface of the latch holder 145 at an acute angle.

The push link 145 presses a crossbar 146, and the crossbar 146 moves the guide mover 115 to open or close the contact unit 110.

The latch holder 147 restrains or releases the latch 143. The latch holder 145 restrains the on-off locking portion 143a of the latch 143 in a normal state operation, and releases the on-off locking portion 143a of the latch 143 during occurrence of an overcurrent or a short-circuit current to thereby allow a trip operation.

Hereinafter, the normal state operation is described. When a user turns the handle 141 in an off state as shown in FIG. 6, the on-off locking portion 143a of the latch 143 is caught and restrained on a side surface portion of the latch holder 145. Thus, as the first U pin 149 and the second U pin 144 are pushed to a left side in the drawing, the push link 145 rotates counterclockwise. When the push link 145 rotates counterclockwise, force having pressed the crossbar 146 is removed, and the movable contact 113 is brought into contact with the fixed contact 111 by elastic force of the contact spring 117. Thus, a circuit is electrically connected, and the handle is positioned in an on state (switched to a state shown in FIG. 5).

At this time, the latch holder 145 restrains the latch 143 and maintains an electrical connection state. That is, the on-off locking portion 143a of the latch 143 is in a state of being caught on the latch holder 145 (FIG. 5).

Likewise, when the user turns the handle 141 in an opposite direction to switch from the on state to an off state, the on-off locking portion 143a of the latch 143 is also caught on the latch holder 145.

That is, in a normal on-off operation by the user's manipulation, the on-off locking portion 143a of the latch 143 is caught and restrained by the latch holder 145. That is, the on-off locking portion 143a moves between the state of FIG. 5 to the state of FIG. 6 during the normal on-off operation.

Hereinafter, a trip operation is described. First, an overcurrent trip process is described.

When the bimetal 131 of the trip unit 200 is curved due to heat generated when an overcurrent flows through a circuit in an electrical connection state as shown in FIG. 5, the compensation bimetal 136 rotates the latch holder 141 of the opening/closing operating mechanism 140 counterclockwise, through sequential associated movements between the moving plate 134, the moving plate lever 135, and the compensation bimetal 136. Accordingly, a restraint on the latch 143 is released. When the restraint by the latch holder 147 is released, the latch 143 rotates counterclockwise by force of a main spring 148, and the push link 145 presses the crossbar 146 so that the movable contact 113 is separated from the fixed contact 111 to break the circuit.

Then, as the joint gear 142 moves according to restoring force of a joint gear spring, the latch 143 rotates clockwise via the first U pin 149 to return to an off position (the state of FIG. 6). In a case of an overcurrent trip, the latch holder 147 is in an open state, and thus, does not limit return of the latch 142 to the off position (switched to the state of FIG. 6).

Hereinafter, a short-circuit current (fault current) tripping process is described.

When a short-circuit current flows in a circuit in an electrically connected state as shown in FIG. 5, an induced electromagnetic force is generated in the coil 151. Due to the induced electromotive force, the movable core 153 is attracted to the movable core 153, and the trip lever 154 and the trip plate 155 move in association with movement of the movable core 153 to rotate the latch holder 145 counterclockwise. Accordingly, a restraint on the latch 143 is released. When the restraint by the latch holder 147 is released, the latch 143 rotates counterclockwise by force of the main spring 148, and the push link 145 presses the crossbar 146 so that the movable contact 113 is separated from the fixed contact 111 to break the circuit.

Then, as the joint gear 142 moves according to restoring force of the joint gear spring, the latch 143 rotates clockwise via the first U pin 149. However, during an instant trip, since the latch holder 147 does not maintain an open state, the latch 142 is restrained by the trip locking portion 143b caught on a lower surface portion of the latch holder 145, as shown in FIG. 7. Accordingly, the latch 143 cannot rotate to the off position and is placed in a trip position (switched to the state of FIG. 7).

Hereinafter, the trip unit 200 is described in detail.

The trip unit body 170 is disposed. The trip unit body 170 includes a terminal mounting portion 171, a support portion 174, a side wall 176, and the coil attachment portion 179.

The support portion 174 may be configured to have a plate shape. A contact insertion portion 181 on which the fixed contact 111 may be installed is disposed in a lower portion of the support portion 174.

The terminal mounting portion 171 is disposed in one end portion of the support portion 174. The terminal mounting portion 171 may be configured to have a form of a stage or pole with a certain height.

A fastening screw groove 172 into which a fastening screw 185 is coupled is disposed at a center part of the terminal mounting portion 171.

A rod fitting hole 173 into which the terminal rod 160 may be fit is disposed in both walls on the terminal mounting portion 171.

The side wall 176 is disposed on one side surface of the support portion 174. The side wall 176 is configured to have a certain height. One side of the side wall 176 extends to the terminal mounting portion 171.

A shaft groove 178 in which the instant trip lever 154 may be equipped is disposed on another side of the side wall 176. The instant trip lever 154 is rotatably coupled by inserting a rotating shaft portion 155 into the shaft groove 178.

A plurality of insertion grooves 177 into which a bimetal support plate 137 may be fit are disposed in a lower portion of the side wall 176. Since the insertion grooves 177 are disposed adjacent to the support portion 174, the bimetal support plate 137 is in close contact with an upper surface of the support portion 174.

An upper support plate 175 is disposed on the side wall 176. The upper support plate 175 is spaced apart from the support portion 174 by a certain distance.

The coil attachment portion 179 is disposed on the upper support plate 175. The coil attachment portion 179 may be configured to have a shape of a cylinder or a circular pipe. The coil attachment portion 179 protrudes upward from the upper support plate 175. The coil attachment portion 179 is disposed inside the coil 151. That is, a sectional diameter of the coil attachment portion 179 is configured to be smaller than an inner diameter of the coil 151.

The coil attachment portion 179 may be disposed integrally with the trip unit body 170 together with the support portion 174. Since the coil attachment portion 179 is disposed on the trip unit body 170, a separate constituent device such as a bobbin for installing the coil 151 is not needed. Therefore, a number of components is reduced, assembling is easy, and management is easy.

The heater assembly 130 is disposed. The heater assembly 130 includes the bimetal 131, the heater 133, and the bimetal support plate 137.

The bimetal 131 is curved by heat flowing through the terminal unit 106 or the heater 133. The bimetal 131 may be disposed integrally with the bimetal support plate 137.

A temperature of the heater 133 increases due to heat flowing through the terminal unit 106.

A plurality of insertion protrusions 138 fit and coupled into the insertion grooves 177 in the side wall 176 are disposed to protrude from the bimetal support plate 137.

The heater assembly 130 is used as a delay trip device.

The coil 151 is disposed. The coil 151 generates an induced electromagnetic force according to an amount of change in a current generated in the terminal unit 106. The coil 151 is inserted into the coil attachment portion 179 of the trip unit body 170. The coil 151 generates an induced electromotive force to generate a magnetic force in the fixed core 152 and the movable core 153.

The core units 152, 153, and 158 are disposed. The core units include the fixed core 152, the movable core 153, and a core spring 158. The core units are inserted and installed into the coil 151.

The fixed core 152 is disposed. The fixed core 152 is fixed by inserting an upper protrusion 152a into a core insertion hole 161 in the terminal rod 160. In this case, the fixed core 152 may be fit and fixedly coupled into the core insertion hole 161 using a screwing method or the like.

The movable core 153 is disposed. The movable core 153 is disposed to be apart from the fixed core 152 and may linearly move. When an external force is not present, the movable core 153 is spaced apart from the fixed core 152 by the core spring 158. When an induced electromagnetic force is generated in the coil 151, a magnetic force is generated in the movable core 153 and the fixed core 152, and thus, the movable core 153 overcomes a force of the core spring 158 and is pulled toward the fixed core 152.

A lever pressing portion 153a is disposed at a lower end of the movable core 153 to operate the instant trip lever 154. The lever pressing portion 153a may be configured to have a shape of a pin protruding from a lower surface of the movable core 153. When the movable core 153 is raised, a plate portion of the lever pressing portion 153a may push the instant trip lever 154 upward.

The core spring 158 is inserted between the fixed core 152 and the movable core 153. In a normal case when an external force does not work, the core spring 158 allows the movable core 153 to be placed in a position apart from the fixed core 152.

The terminal rod 160 is connected to a load terminal (not shown). The terminal rod 160 is fixedly coupled to the trip unit body 170.

The terminal rod 160 may be configured to have a plate shape like a step. The core insertion hole 161 may be disposed in an upper surface of the terminal rod 160 and have the fixed core 152 inserted therein. The upper surface of the terminal rod 160 is disposed on the coil 151.

A lower surface of the terminal rod 160 may constitute the terminal unit 106. A plurality of fitting protrusions 163 are disposed on the terminal unit 106. The fitting protrusions 163 on the terminal unit 106 are inserted into a rod insertion portion, i.e., the rod fitting hole 173. Accordingly, the terminal rod 160 is fixed to the terminal mounting portion 171 of the trip unit body 170.

A through hole 162 into which the fastening screw 185 is inserted is disposed at a center part of the terminal unit 106.

The instant trip lever 154 is disposed. The rotating shaft portion 155 is disposed on the instant trip lever 154 and fit into the shaft groove 178 in the trip unit body 170.

A driven portion 156 is disposed at a rear end of the instant trip lever 154 and located in a space defined by the lever pressing portion 153a of the movable core 153.

Referring to FIG. 8, a fixing plate 186 for fixing a load terminal may be disposed below the fastening screw 185.

Hereinafter, an assembly operation of the trip device for the manual motor starter according to one embodiment of the present disclosure is described.
1) First, the trip unit body 170 that is designed is prepared.
2) The fixed contact 111 is fit and coupled to the contact insertion portion 181 of the trip unit body 170.
3) The heater assembly 130 is fit and coupled into the insertion grooves 177 in the trip unit body 170.
4) The coil 151 is fit and coupled to the coil attachment portion 179 of the trip unit body 170.
5) The core units 152, 153, and 158 are inserted into the coil 151.
6) The terminal rod 160 is fit and coupled to the terminal mounting portion 171 of the trip unit body 170. The fixed core 152 is fit and coupled onto an upper surface of the terminal rod 160.
7) The instant trip lever 154 is assembled. The instant trip lever 154 is fit and coupled into the shaft groove 178 in the side wall 176 of the trip unit body 170.

The trip device of the manual motor starter according to one embodiment of the present disclosure is configured to have a coil attachment portion on a trip unit body to facilitate assembling of a coil. Accordingly, assembling time may be shortened, and assembly defects rarely occur.

Since a bobbin component applied to assembling of a coil in the related art is removed, a number of components is reduced. Accordingly, manufacture and management of components are improved.

The embodiments described above are only examples of the best modes of practice for implementing the present disclosure, and it will be understood by one of ordinary skill in the art that various changes in form and details may be made therein without departing from the spirit and scope of the present disclosure.

Accordingly, the embodiments described therein should be considered in a descriptive sense only and not for purposes of limitation Therefore, the scope of the technical idea of the present disclosure is not limited by these embodiments. That is, the scope of protection of the present disclosure should be interpreted in accordance with the appended claims, and all technical ideas within the scope will be construed as being included in the scope of the present disclosure.

### DESCRIPTION OF REFERENCE NUMERALS

101: Enclosure
105, 106: Terminal unit
110: Contact unit
111: Fixed contact
113: Movable contact
120: Arc extinguishing unit
130: Heater assembly
131: Bimetal
133: Heater
137: Bimetal support plate
138: Insertion protrusion
140: Opening/closing operating mechanism
141: Handle
151: Coil
152: Fixed core
152a: Upper protrusion
153: Movable core
153a: Lever pressing portion
154: Instant trip lever
155: Rotating shaft portion
156: Driven portion
158: Core spring
160: Terminal rod
161: Core insertion hole
162: Through hole
163: Fitting protrusion
170: Trip unit body
171: Terminal mounting portion
172: Fastening screw groove
173: Rod insertion hole
174: Support portion
175: Upper support plate
176: Side wall
177: Insertion groove
178: Shaft groove
179: Coil attachment portion
181: Contact insertion portion
200: Trip unit

1. A trip device for a manual motor starter, the trip device comprising:
a trip unit body constituting a base of a trip unit;
a fixed contact coupled to a lower portion of the trip unit body;
a heater assembly inserted and coupled into the trip unit body and configured to detect a heat variation;
a coil coupled to an upper portion of the trip unit body;
a core unit inserted into the coil;
a terminal rod coupled to the core unit and the trip unit body and having one end constituting a terminal unit; and
an instant trip lever rotatably coupled to the trip unit body and operated by the core unit,
wherein a coil attachment portion into which the coil is installed to be inserted is disposed to protrude on the trip unit body.

2. The trip device of claim 1, wherein a contact insertion portion into which the fixed contact is fit to be coupled is disposed on the trip unit body.

3. The trip device of claim 1, wherein a terminal mounting portion is disposed on one end portion of the trip unit body, and
a rod fitting hole into which the terminal rod is fit to be coupled is disposed in the terminal mounting portion.

4. The trip device of claim 1, wherein the coil attachment portion is disposed on an upper support plate of the trip unit body, and
a side wall is disposed between the upper support plate and a support portion of the trip unit body.

5. The trip device of claim 4, wherein an insertion groove into which the heater assembly is fit to be coupled is disposed in the side wall.

6. The trip device of claim 4, wherein the heater assembly comprises a heater, a bimetal, and a bimetal support plate, and
a plurality of insertion protrusions fit into the insertion groove are disposed to protrude on the bimetal support plate.

7. The trip device of claim 1, wherein a shaft groove into which a rotating shaft portion of the instant trip lever is fit to be coupled is disposed in the side wall.

8. The trip device of claim 1, wherein the core unit comprises a fixed core, a movable core, and a core spring, and
the fixed core is fixed onto an upper surface of the terminal rod.

9. The trip device of claim 8, wherein a lever pressing portion configured to operate the instant trip lever is disposed on a lower portion of the movable core.

10. The trip device of claim 3, wherein a fitting protrusion fit to be coupled into the terminal mounting portion is disposed on the terminal unit located on a lower surface of the terminal rod.

11. The trip device of claim 1, wherein the coil attachment portion is configured to have a shape of a cylinder or a circular pipe.

12. The trip device of claim 1, wherein the coil attachment portion is disposed inside the coil.
